(19) United States
(12) Patent Application Publication
(10) Pub. No.: US 2024/0013152 A1
(43) Pub. Date: Jan. 11, 2024

(54) SYSTEM AND METHOD FOR AN ENHANCED INTERACTIVE DIGITAL EVENT DESIGN PLATFORM

(71) Applicant: The Labz Inc., Atlanta, GA (US)

(72) Inventors: Farah F. Allen, Mableton, GA (US); Lucien L Wall, Mableton, GA (US)

(73) Assignee: The Labz Inc., Atlanta, GA (US)

(21) Appl. No.: 18/350,579

(22) Filed: Jul. 11, 2023

Related U.S. Application Data
(60) Provisional application No. 63/388,130, filed on Jul. 11, 2022.

(51) Int. Cl. G06Q 10/101; G06F 3/0486; G06F 3/04815

(52) U.S. Cl. CPC G06Q 10/101; G06F 3/0486; G06F 3/04815

(57) ABSTRACT

A system, method, and platform for creating a digital environment. The digital environment is created from a template. One or more tools associated with a field of the digital environment is communicated. Content and drag-and-drop selections are received from one or more users. Ownership and contributions by each of the one or more users are documented in blockchain.

### PRIORITY

This application claims priority to pending U.S. provisional patent application Ser. No. 63/388,130 entitled “SYSTEM AND METHOD FOR AN ENHANCED INTERACTIVE DIGITAL EVENT DESIGN PLATFORM”, filed Jul. 11, 2022, the entire contents of which are hereby incorporated by reference in their entirety.

### BACKGROUND

### I. Field of the Disclosure

The illustrative embodiments relate to a digital design platform. More specifically, but not exclusively, the illustrative embodiments relate to a system, method, and platform for providing a no-code digital design platform environment for creating an interactive digital environment.

### II. Description of the Art

As digital events and other web-based destinations have continued to evolve, so have the limitations related to the expense and time required to create these enhanced virtual and digital destinations. Due to the complex nature of the creation process, a design and coding background is typically required to design, code, and integrate enhanced web-based experiences. For example, current virtual event technology is limited to a single login connecting multiple users within a video-to-video virtual room format. These formats are tied to the fixed video telephony environment with very few customizable elements available past the simple multi-user video telecommunication-based implementation. The main selling point of these single purpose virtual event platforms is that they add some minor functionality or communication elements, such as text or social media, to a standard video call environment furthering a single purpose content delivery process that does not capture guest attention or maintain user interest.

### SUMMARY OF THE DISCLOSURE

The illustrative embodiments provide a system, method, and platform for creating a digital environment. The digital environment is created from a template. One or more tools associated with a field of the digital environment is communicated. Content and drag-and-drop selections are received from one or more users. Ownership and contributions by each of the one or more users are documented in blockchain. In other embodiments, a system may include a processor for executing a set of instructions and a memory for storing the set of instructions. The set of instructions may be executed by the processor to perform the method herein described.

In other embodiments, the digital environment or portions of the digital environment may be licensed to third parties. The portions of the digital environment may include content uploaded to the digital environment. The one or more users may be compensated for utilization of the digital environment or content associated with the digital environment. A lounge or one or more rooms for the digital environment may be established. Virtual objects, decorations, and functionalities with associated content and links may be embedded within the digital environment. Communications may be enabled within the lounge or one or more rooms. Engagements and biometrics of participants are tracked within at least the digital environment. The digital environment may include a number of virtual reality/augmented reality/mixed reality headsets with biometric sensors including EEG, heart rate, temperature, respiration, eye position, body position, eye location (e.g., GPS, triangulation, RFID, etc.) and other applicable user biometrics and information. The digital environment may be hosted by a data platform and/or server implementing artificial intelligence and machine learning logic to communicate with multiple wireless devices (e.g., smart phones, tablets, computers, headsets, gaming devices, biometric sensors, etc.) through one or more networks. The server, wireless devices, and networks may be dedicated for the digital environment and associated user interfaces, displays, and information. The digital environment may provide tracking information across the digital environment. The digital environment may allow inexperienced users to create other digital environments utilizing a drag and drop process through any number of computing, electronic, or wireless devices.

Another embodiment provides a system for generating a digital environment. The digital environment may include electronic devices executing an interface application. The interface application is configured to communicate one or more digital environments include a digital environment. The system further includes a platform accessible by the wireless devices executing the interface application through one or more networks. The platform creates the digital environment from a template, communicates one or more tools associated with a field of the digital environment, receives content, and drag-and-drop selections from one or more users, and documents ownership and contributions by each of the one or more users in blockchain.

### BRIEF DESCRIPTION OF THE DRAWINGS

Illustrated embodiments are described in detail below with reference to the attached drawing figures, which are incorporated by reference herein, and where:

FIG. 1 is a pictorial representation of a system for managing interactive environments in accordance with an illustrative embodiment;

FIG. 2 further illustrates portions of the system of FIG. 1 in accordance with an illustrative embodiment;

FIG. 3 is a flowchart of a process for creating a digital environment in accordance with an illustrative embodiment;

FIG. 5 is a flowchart of a process for compensating a user for utilization of a digital environment in accordance with an illustrative embodiment;

FIG. 5 is a flowchart of a process for implementing a virtual environment in accordance with an illustrative embodiment;

FIG. 6 is a flowchart of a process for rewarding engagement in accordance with an illustrative embodiment;

FIG. 7 is a flowchart of a process for configuring an event in accordance with an illustrative embodiment;

FIG. 8 is a flowchart of a process for creating a virtual networking event in accordance with an illustrative embodiment;

FIG. 9 is a pictorial representation of a tool for creating a digital environment in accordance with an illustrative embodiment;

FIG. 10 depicts a computing system in accordance with an illustrative embodiment.

### DETAILED DESCRIPTION OF THE DISCLOSURE

The illustrative embodiments provide a system, method, and platform for an interactive digital event design platform. As described below, the following description and content is applicable to all of the Figures without limitation. The platform may utilize a combination of proprietary feature sets and digital design creation tools utilizing a robust multi-media toolbox (e.g., audio, video, text, links, images, video chat, etc.) that may be integrated via codeless drag and drop functionality to curate unique and dynamic interactive content. The content may be targeted, communication-rich virtual events, interactive 360 destinations, digital events, interactive multi-media environments, live event experiences, meta verse-based worlds, and avatar-based virtual worlds. The illustrative embodiments may facilitate the seamless creation and customization of any interactive digital environment. For example, various specific user interfaces may be utilized to create the digital environments as well as present the digital environments themselves. The platform may include special hardware and software for hosting the digital environments, communicating the digital environment and the associated data and information.

As the internet and the digital revolution continues to evolve, so has the ability to create more dynamic and functional virtual web event destinations and experiences. This evolution has moved us away from the single purpose websites, which are quickly becoming outdated and are being replaced by virtual and hybrid interactive online experiences, digital destinations, and 360° environments. The illustrative embodiments set the stage for scalable solutions to help business leaders and creatives of all types compete and thrive in the virtual event destination and metaverse era.

The illustrative embodiments provide a platform including a suite of widgets and application program interfaces (APIs) that enables the user integration of fully customizable digital design components and functionality for the creation of connected digital events and 360° environments. These improvements facilitate content design integration, collaboration, and user interaction into a single platform. The platform may be used for the creation and administration of one of a kind targeted digital event spaces. The spaces may be tailored for each of the hosts and users needs and vision and provides for more impactful and meaningful audience interaction and engagement than was previously possible with standard clickable websites, video-to-video event platforms, and/or standard video event conferencing tools.

An illustrative embodiment provides a single source platform used for the creation and implementation of improved interactive digital environments and event style experiences through the utilization and cross pollination of various technologies, widgets, second screen functionality, and customer data tracking components. This cross pollination of technologies, combined with the ability to fully customize each digital environment is enhanced through the inclusion of drag and drop site builder and toolbox functionality that allows for the design, customization, and integration of unlimited 360° digital environments and digital events. The illustrative embodiments improve digital event creation with enhanced features for digital destination customizations that includes the codeless integration of links and triggers to objects, interactive content, in-site triggers, customizable backgrounds, and second screen activations, which are used to facilitate the creation of an improved customized and targeted digital event environment that may set new standards for evolution in the field.

One embodiment provides a single platform including a single source graphical user interface that utilizes a proprietary code-less drag and drop toolbar for the implementation of an improved interactive virtual design platform and digital content creation tool that incorporates a broad range of feature sets and functionalities that enables the creation of unique digital destinations with customizable capabilities across each digital world or metaverse based environment. The platform may be used to create an array of content, virtual events across digital destinations, virtual environments, 360° digital environments, NFT Minting environments, branded fan activations, brand destinations, shopping experiences, film launches, interactive stories, podcasts, virtual fashion shows, virtual pop-up's, virtual water coolers, 360° worlds, collaboration environments, metaverse worlds, avatar worlds, art exhibits, virtual listening parties, product launches, festivals, conferences, courses, classes, demos, galas, and awards. The platform may be customized and modified to apply to countless virtual and digital configurations and combinations. These configurations may be customizable and are interchangeable based on user requirements.

That platform may also include multichannel community communication tools that provides improved user connectivity, collaboration, and customizable interactions across each newly implemented environment. The communication tools may also be used to facilitate virtual collaboration across teams or may make virtual collaboration suggestions or matches based on collected user data or based on a user's verified desire to collaborate within a specific room or environment. The platform may also generate user connection recommendations based on onboarding or in-site data collection that allows like-minded users to connect virtually in real-time or connect with another user in a specific environment at the same time and explore, communicate, and collaborate together in the virtual environment itself.

The fully customizable environments enabled by the platform support full multimedia functionality and ‘on the fly’ customizations that quickly and easily integrates into any customizable environment and allows for the implementation of a code free design and customizable event and event collaboration process that facilitates a wide range of features and functions such as audio, live and pre-recorded video, text, links, images, chat, video chat automation, games, social media integration, and multi-media support for improved scalability.

The illustrative embodiments provide improved scalability, customization, and ease of use for the creation and design of each new digital experience. The platform's seamless drag and drop features provides a codeless event creation tool that enables the customization of enhanced digital environments that do not rely on templated layouts, formulaic code structures, or patterned designs.

The platform's customization features provide the event host with greater creative control and scalability by providing a single source platform for hosting a broader range of virtual event types, site functionality, and virtual event purpose.

Event hosts may choose from a wide range of event types to determine the event purpose, functionality, and event look and feel to better capture the personality of the host or brand across each digital environment. In addition to the fully customizable content the platform integrates a number of social and user connected social interaction features including multichannel community communication, live communication widgets, social media connections, which are all utilized to improve user communication, connectivity, interactivity, collaboration, and site stickiness for site visitors across all platform utilizations.

The full customization of the design and feature choices, combined with a convenient code free toolbox with a drag and drop creation tool provide a codeless fully customizable digital design experience which facilitates a broader range of design choices and ease of implementation across each digital destination, which helps to keep users better engaged in the site and provides a brand destination for improved user connectivity and customization of each unique user engagement.

Additionally, the platform may integrate automation and workflow-based design components that provide the ability to customize the automation of each digital environments' functionality. The site automation customizations may perform interactive tasks and customize and manage the automated functions and event purpose creating the ability to tailor the site automation of each environment or room to the event requirements. The platform may be fully customized based on the event need through the implementation and integration of program ads, buttons, site functions, timed automation for videos, and music, which may be further customized to start within a timed workflow or based on other user required conditions such as behavior or interests.

In one embodiment, the platform integrates interactive widgets that allow for the full customization of each 360° or avatar based digital environment. The platform allows users to upload and customize each aspect related to the layout, design, look, and feel to ensure each 3D environment is unique and non-reliant on templates or fixed formats. The platform allows the user to integrate and customize social media and communication widgets such as text, audio, telephony, video chat, 3rd party chat, VoIP, instant messaging, AR Headsets and may integrate other 3rd party plug-ins, to create an improved immersive event based digital distribution platform. For example, the platform enhances the ability to create and customize an unlimited range of event, brand, or content destinations and add greater social connectivity and collaboration through the inclusion of community tools like social media feeds, chat, photobooths, Augmented Reality (AR), and livestreams.

In one embodiment the platform allows for the upload and integration of personal, corporate, or brand based digital assets through the seamless toolbox, codeless design and embedding functionality that allows for the improved implementation of content and may integrate added functionality from other 3 rd party sites or internally created assets to better implement outside digital assets, activities, games, social media functions, and so forth into each digital environment.

In one embodiment, the platform's utilization of interactive widgets provides improved customization, user interaction, and data tracking across all environments. The platform facilitates real-time director control and design customization that allows for the inclusion and modification of interactive widgets, content modifications, and event updates within each experience in real-time. The improved user control and fully customizable design features allow for the conception, upload, and configuration of limitless design layouts and content utilizations across each digital environment.

The platform also provides for an improved processes for the inclusion and integration of limitless real-time user environment customization, layouts, text, site configurations and site functionality through the added ability to quickly drag and drop codeless design features into each 360° environments and to integrate widgets, such as audio, video chat, and video for improved user social connectivity, site customization, digital environment layout, content design, and improved feature integration and functionality that requires no additional coding knowledge.

In one embodiment, the platform facilitates the integration and utilization of virtual photo booths and filters to add a branded sharable augmented reality environment functionality for deeper audience collaboration, matchmaking, engagement, and participation for a more customized, social, and interactive digital event experience.

In one embodiment the platform provides improved user, brand, and destination stickiness, outreach, and connectivity through the inclusion of Know Your Customer (KYC) features, such as onboarding an in-site data collection, case studies, use cases, surveys, real-time polls, audio, video, opinions, critical writing, gamification, content collaboration and may track each user in the environment to validate the number of events visited, ingested content, user interest, and verified content interactions (e.g., videos consumed). This data and information provide a unique ability to customize and tailor the purpose or the look and feel of each themed room through the inclusion of KYC features.

In one embodiment a biometric readout such as a thumbprint or retina fingerprint, facial, voice, iris, voice recognition, or palm scan to connect users to each environment, which provides instant user recognition and authentication across each destination and may be used to track and store each virtual prize, badges, collected items, in-site points, purchases, and collections associated with the profile. The biometrics may also be used for attendee tracking and engagement and as a secondary method to confirm a user has visited each site destination or returned to interact with a virtual environment and may indicate physical biometric readouts related to a user's experience during exploration of each site. Additionally, customized chat and language filters may be used to measure contributions and thought leadership and emoji, or avatar-based reaction indicators may be captured and measured to indicate user response within each event or digital environment. Additionally, loyalty points, virtual gifts or prizes may be used to entice users to participate, share data, collaborate, and interact within each event environment to better facilitate deeper event participation.

The platform may integrate with AI to support a UX and Speech Interface Framework to navigate sites by voice commands, which allows for voice-controlled log-in and site navigation which provides for improved control and experience accessibility for all users.

The platform may also utilize a voice recognition application that allows users to log in to the platform via voice command, and make a distinction related to the voice associated with each profile, which will associate the voice, login, and content with a specific user. Users may enter the workspace and then create, edit, and manage within the platform through voice and visual commands to build their own experience.

In one embodiment, the platform may scale with volume hosting to accommodate any sized virtual audience and may scale from a single event to the integration of a virtual water cooler environment, virtual headquarters, multi-level/multi-floor shopping experience all the way to a virtual skyscraper or a full virtual digital real estate environment dedicated to a user, corporation, or brand. This ability to scale provides the unique feature of unlimited virtual event capacity and may be used for connected events such as virtual listening parties, virtual concerts or for a networked virtual podcast.

The illustrative embodiments provide for enhanced digital ownership, audio hosting, and content security features, which allows content creators to use the platform for hosting content in a more secure event environment that prevents their content feed from being accessed, copied, or used by any other 3rd party sites outside of those controlled by the user within the platform.

In one embodiment, a virtual networking and collaboration environment is created. Onboarding data is collected to match, target, and connect users based on shared data sets or user profile determined matchmaking elements. Connections for collaboration are facilitated within the custom environment and users are linked in a virtual collaboration environment via in-environment interactions or through video or chat. These environments may be used to connect any matching data or profile components, such as job title matching (e.g., CEOs, CODs, legal counsel, etc.), interests, job search, networking, sales, company needs, and so forth. Any number of questionnaires, surveys, onboarding requests, or other data and information may be received from the user. This functionality may also be used for lookalike audience targeting and matching for outreach or community collaboration.

In one embodiment a drag and drop musical collaboration environment is created that provides the ability to connect musicians in a virtual space in order to virtually collaborate musically in real-time or via asynchronous collaboration to capture and produce high quality audio files for music, television, commercials, film, or podcasts. For example, a drag and drop collaboration environment may be virtually equipped with digital recording equipment that captures musical collaboration from virtual and real-world instruments. The virtual environments may be used to collaborate on composition, arrangements, sound design, production, mixing, and mastering. The platform may also be used to track ownership and records of collaboration from users, in order to produce a split sheet for final audio extracted. The split sheet agreements may be documented on the blockchain and identify each producer and songwriter and state the contributor's ownership percentage and each musician's performing rights organization.

In one embodiment the platform creates an environment that is connected or utilized through Ethereum or other blockchain networks. As a result, user may be allowed to create experiences and document and manage ownership of their digital creation on the blockchain for an improved record of digital event ownership and documentation. Blockchain utilization allows for the creation and minting of each user created environment to add a secondary ownership and NFT content creation tracking that facilitates license and monetization features to each NFT environment created on the platform. In the same fashion an NFT minting utilization may be used within the site to create an NFT museum type environment where NFT art may be displayed virtually for the purpose of providing a means to create, mint, and sell unique NFT's of a specific digital work. The minting process and NFT creation may also be purchased with branded crypto issued from the site or platform provider.

In one embodiment, know your customer data tracking components may be utilized to customize and enhance each site experience through standard data collection techniques, or consumer elected inclusion of data collection elements or the user may be asked to share static data such as name, email, business, job title, address, time zone, language, college, age, gender and so forth. The platform may also facilitate, and capture opinion-based data collection gathered from consumer interactions around product questions and answers, live polling, feedback, surveys, product likes, dislikes, interests and so forth. The user may also elect to share employment network, social network, (e.g., LinkedIn, Facebook, Instagram, Alignable, Twitter, etc.), which are also used to customize site content, purpose, matchmaking, collaboration, and improve secondary event outreach.

In one embodiment, in-site gamification may be tied to virtual prizes and event badges that require the user profile to fully explore each environment to earn a badge, reward, token, or to discover prizes or items within each room or environment. The badges, tokens, rewards, and prizes may be displayed or used within each virtual event environment and can be collected, stored, and accessed for use across other virtual environments via a login or biometric passcode. For instance, environments may be customized based on collectible or discoverable virtual event items or gifts such a virtual item for an avatar, songs, mp3's, branded items, virtual collectibles, which may be used, transported, and accessed across each connected virtual environment.

In one embodiment data or content is collected and carried across each virtual room or environment. The content, virtual recommendations, and the site look, and feel may be customized based on previously collected or newly collected onboarding, item collection, surveys, and a badge collection process that enables the customization of each newly visited virtual environment based on onboarding data, percentage of site visited, and user collected content.

In one embodiment, artificial intelligence and in-site or second screen functionality may be used to virtually moderate an event or provide second screen interactions within each site. In this embodiment in-site or second screen activations are used to enable gamifications, capture QR's or other identifiers, find and capture hidden items, maps, and ingest ownable content for unique and improved marketing activations and second screen moderator and storytelling functionality.

The inclusion of these data collection components and elements allows for greater site functionality and customization. In site or second screen virtual moderators may welcome users by name, quickly point users to specific site information, and make recommendations to ensure users explore each environment more fully and measure user engagement. Automated artificial intelligence driven moderator suggestions are based on captured data such as percentage of site visited, page views, preferred content, and through in-site verifications for rooms that have been visited. This collected data informs the artificial intelligence tracking and scripted recommendations and allows hosts to create scripted goal funnels through the data driven and scripted artificial intelligence-based moderator suggestions that may indicate undiscovered areas or provide insights or clues, maps, items of interest, or purchase suggestions, related to each environment within a site. In non-moderated environments these suggestions may also be indicated through in-site visual cues, such as a section of the site that lights up or moves, are visually highlighted to indicate areas a user should visit, or clues about the room or suggestions for purchases to help keep users engaged.

The second screen functionality also facilitates transfer of music/mp3s, artwork, games, prizes, or other event related items or purchases from a site to device. An example is a user interacting with a fixed screen such as a desktop computer or with a digital display not owned by the consumer. The consumer via their device is able to capture and interact with elements on the fixed screen such as QR codes, downloads, videos, music, purchases, and so forth.

In one embodiment, the platform's inclusion of multichannel community communication tools allows for enhanced social customer interaction and connectivity for improved social engagement which converts to increased marketing and secondary brand outreach. These social connectivity features may further integrate and improve each unique ecommerce activation, marketing outreach, collaboration connections, custom storytelling features, gamification, NFT creation, advanced data collection and instant customer feedback.

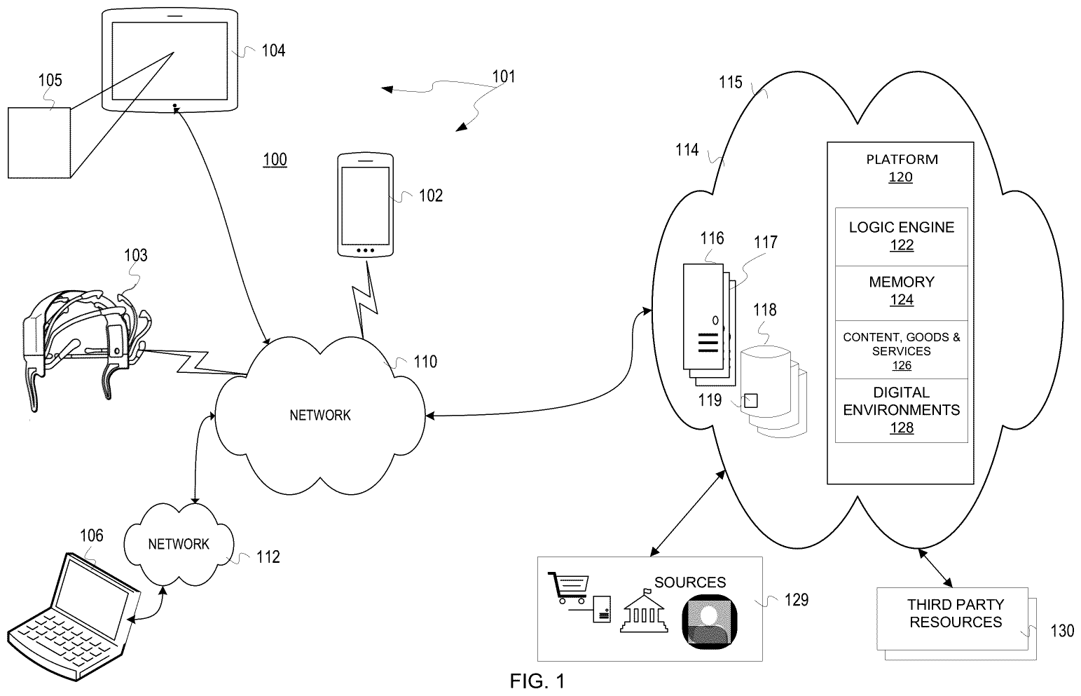

FIG. 1 is a pictorial representation of a system 100 for managing interactive environments in accordance with an illustrative embodiment. In one embodiment, the system 100 of FIG. 1 may include any number of devices 101, networks, components, software, hardware, and so forth. In one example, the system 100 may include a smart phone 102, a headset 103, and a tablet 104 displaying a graphical user interface 105, a laptop 106 (altogether devices 101), a network 110, a network 112, a cloud system 114, servers 116, databases 118, a platform 120 including at least a logic engine 122 and a memory 124. The cloud system 114 may further communicate with sources 129 and third-party resources 130.

Each of the devices, systems, and equipment of the system 100 may include any number of computing and telecommunications components, devices or elements which may include processors, memories, caches, busses, motherboards, chips, traces, wires, pins, circuits, ports, interfaces, cards, converters, adapters, connections, transceivers, displays, antennas, operating systems, kernels, modules, scripts, firmware, sets of instructions, and other similar components and software that are not described herein for purposes of simplicity.

In one embodiment, the system 100 may be utilized by any number of users, organizations, or providers to create, manage, review, analyze, process, advertise, market, display, and/or distribute digital environments that may include content, communications, products, and/or services. In one embodiment, the goods and services may represent artwork, music, NFTs, files, items, content, products, goods, or services sold by a user, business, group, organization, or entity. In one embodiment, the system 100 may utilize any number of secure identifiers (e.g., passwords, pin numbers, certificates, etc.), secure channels, connections, or links, virtual private networks, biometrics, or so forth to upload, manage, and secure the goods and services and process applicable transactions. The devices 101 are representative of multiple devices that may be utilized by users, businesses, or consumers, including consumer, network, and business devices and associated operating systems, programs, sets of instruction, scripts, kernels, and other software, and may also include devices integrated with or utilized by the cloud system 114. The devices 101 utilize any number of applications, browsers, gateways, bridges, or interfaces to communicate with the cloud system 114, platform 120, and/or associated components.

The wireless device 102, headset 103, tablet 104, and laptop 106 are examples of common devices that may be utilized to access the systems, platforms, and tools herein described to create, edit, manage, and update digital environments 128, upload or contribute content, ideas, and comments, and otherwise interact. The headset 103 may be a virtual reality headset, augmented reality headset, heads up display. Other examples of devices 101 may include virtual reality headsets, e-readers, cameras, video cameras, audio systems, gaming devices, vehicle systems, art systems, kiosks, point of sale systems, televisions, smart displays, monitors, entertainment devices, holographic systems, augmented reality systems, or so forth. The devices 101 may communicate wirelessly or through any number of fixed/hardwired connections, networks, signals, protocols, formats, or so forth. In one embodiment, the smart phone 102 is a cell phone that communicates with the network 110 through a 5G connection (or other connection 3G, 4G, LTE, UE, 6G, etc.). The laptop 106 may communicate with the network 112 through an Ethernet, cellular, or Wi-Fi connection.

The cloud system 114 may aggregate, manage, analyze, and process content and user requests across the Internet and any number of networks, sources 129, and third-party resources 130. For example, the networks 110, 112, cloud system 114 may represent any number of public, private, virtual, specialty, or other network types or configurations. The different components of the system 100, including the devices 101 may be configured to communicate using wireless communications, such as Bluetooth, Wi-Fi, or so forth. Alternatively, the devices 101 may communicate utilizing satellite connections, Wi-Fi, 3G, 4G, 5G, LTE, 6G, personal communications systems, DMA wireless networks, and/or hardwired connections, such as fiber optics, T1, cable, DSL, high speed trunks, powerline communications, and telephone lines. Any number of communications architectures including client-server, network rings, peer-to-peer, n-tier, application server, mesh networks, fog networks, or other distributed or network system architectures may be utilized. The networks, 110, 112, cloud system 114 of the system 100 may represent a single communication service provider or multiple communications services providers.

The cloud system 114 may also be a blockchain system 115. The blockchain system 115 creates a digital ledger 119 of transactions that are duplicated and distributed across the entire network/system of computers on the blockchain. Each block in the chain contains a number of transactions and every time a new transaction occurs on the blockchain, a record of that transaction is added to the ledger 119 (and other decentralized and distributed ledgers). The transactions are recorded with an immutable cryptographic signature or similar distinguisher based on developments in blockchain technology.

The sources 129 may represent any number of web servers, communications services (e.g., text, email, video, conferencing, NFTs, etc.), media servers, platforms, distribution devices, software servers/services, or so forth. In one embodiment, the sources 129 may represent the groups, individuals, or entities that the system 100. The cloud system 114 (or alternatively the cloud network) including the platform 120 is specially configured to perform the illustrative embodiments. In one example, the sources 129 may include communications services, such as Discord®, Skype®, Google chat, Zoom, and other similar companies. The platform 120 may also host streaming and feeds. For example, the user may ensure that an associated RSS feed cannot be copied or duplicated by other sites outside of those controlled by the user through the platform 120. The platform 120 may be utilized to control and manage content utilizing blockchain technologies. In other examples, the user may be able to create and utilize custom emojis and chat language filters that may be customized and utilized. These features may be unique and drive traffic and utilization of specific environments.

The sources 129 may also represent social media networks and services or social media may be accessed utilizing applications, browsers, or software on the devices 101. The users may share information and data about websites, events, content, collaborations, and so forth. The various features, functionality, and components of social media networks and applications may also be integrated with the system 100 as needed or implemented.

The cloud system 114 or network represents a cloud computing environment and network utilized to create, aggregate, process, manage, sell, and distribute digital environments 128 and content. The cloud system 114 allows digital environments 128 from multiple businesses, users, managers, or service providers to be centralized. In addition, the cloud system 114 may remotely manage configuration, software, and computation resources for the devices of the system 100, such as devices 101. The cloud system 114 may prevent unauthorized access to data, tools, and resources stored in the servers 116, databases 118, and well as any number of associated secured connections, virtual resources, modules, applications, components, devices, or so forth. In addition, a business may more quickly upload, aggregate, process, manage, and distribute environments and content, where authorized, utilizing the cloud resources of the cloud system 114 and platform 120. The cloud system 114 allows the overall system 100 to be scalable for quickly adding and removing businesses, users, authorized sellers, resources, bandwidth, servers, analysis modules, moderators, programs, scripts, filters, transaction processes, distribution partners, or other users, devices, processes, or resources. Communications with the cloud system 114 may utilize encryption, secure tunnels, handshakes, secure identifiers (e.g., passwords, pins, keys, scripts, biometrics, etc.), firewalls, specialized software modules, or other data security systems and methodologies as are known in the art.

Although not shown, the cloud system 114 may include any number of load balancers. The load balancer is one or more devices configured to distribute the workload of processing the digital environments 128, transactions, and other content to optimize resource utilization, throughput, and minimize response time and overload. For example, the load balancer may represent a multilayer switch, database load balancer, or a domain name system server. The load balancer may facilitate communications and functionality (e.g., ledger entries, hash processing, database queries, read requests, write requests, command communications, stream processing, etc.) between the devices 101 and the cloud system 114. For example, the cloud system 114 may offload verification information for new businesses and digital environments 128 that seek to be added to the system 100 along with applicable configurations and content. Load balancing may be performed between automatic systems and devices as well as individual users. Other intelligent network devices may also be utilized within the cloud system 114.

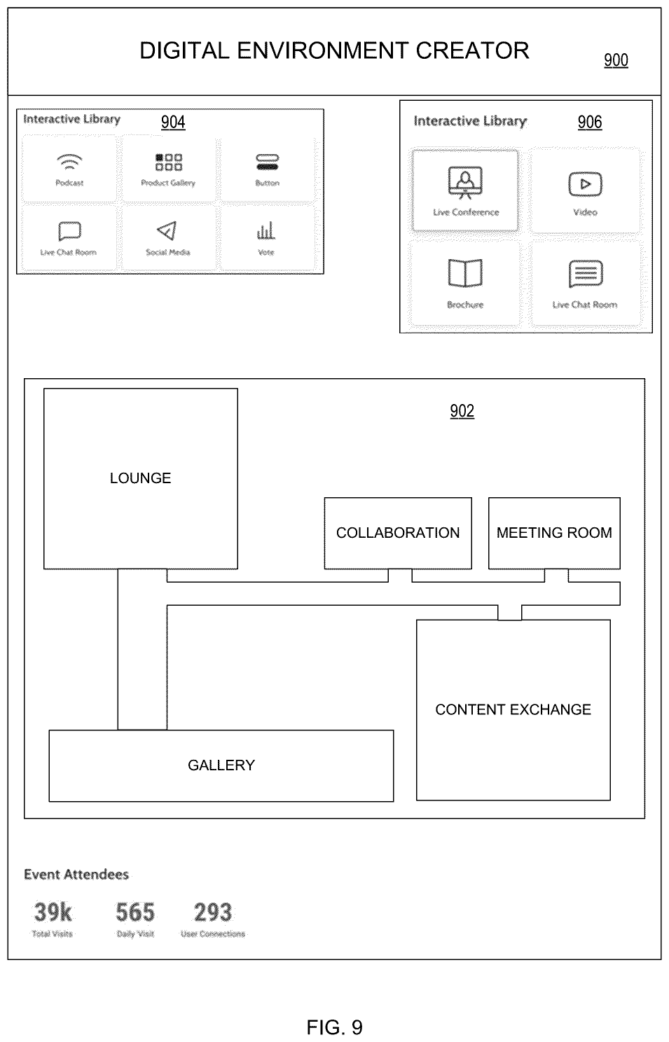

The servers 116 and databases 118 may represent a portion of the platform 120. In one embodiment, the servers 116 may include a web server 117 utilized to provide a website and user interface (e.g., tool 900 of FIG. 9, user interface 107) for interfacing with numerous users. Information received by the web server 117 may be managed by the platform 120 managing the servers 116 and associated databases 118. For example, the web server 117 may communicate with the database 118 to respond to read and write requests. The databases 118 may utilize any number of database architectures and database management systems (DBMS) as are known in the art. The databases 118 may store the content associated with each consumer/purchaser/user which may specify an address, name, age, biometric identifiers, payment information, location, cause preferences, cause restrictions, and so forth. The database 118 may also include environment, content, products/items/services, and so forth. Any number of secure identifiers, such as inaudible tones, QR codes, serial numbers, or so forth may be utilized to ensure that content, personal, or transaction information is not improperly shared or accessed.

In one embodiment, the user interface 105 is a portion of an interface, digital environment, or data application (not shown) executed by the devices 101. For example, the user interface 105 may represent the portion of the platform visible to the user for communicating and receiving environments, information, data, and content. The user interface 105 may be made available through the various devices 101 of the system 100. In one embodiment, the user interface 105 represents a graphical user interface, audio interface, or other interface that may be utilized to communicate, display, receive, and otherwise manage data and information. For example, the user may navigate digital environments 128, content, software tools, products, and services utilizing the user interface 105. The user interface 105 may utilize any number of libraries, windows, icons, drop-down menus, graphics, images, and content. The graphical user interface 105 may be presented based on execution of one or more applications, browsers, kernels, modules, scripts, operating systems, or specialized software that is executed by one of the respective devices 101. The user interface may display current and historical statistics, information, and/or data as well as trends. The user interface 105 may be utilized to set the user preferences, parameters, and configurations of the devices 101 for the digital environments 128 and users as well as upload and manage the content sent to the cloud system 114.

In another embodiment, the user interface 105 is a voice interface. The voice interface and command interface may be utilized to create, control, and manage the digital environments 128 and may also be utilized by consumers that are navigating the digital environments 128. The voice interface may utilize artificial intelligence to create and manage the digital environments. Any number of existing AI logic systems may be utilized, such as Amazon Alexa, Google Assist, Apple Siri, Microsoft Cortana, and so forth.

In one embodiment, the system 100 or the cloud system 114 may also include the platform 120 which is one or more devices utilized to create, modify, update, enable, initiate, aggregate, analyze, process, and manage digital environments 128, content, goods, services 126, and so forth with one or more communications or computing devices. The platform 120 may include one or more devices networked to manage the cloud network and system 114. For example, the platform 120 may include any number of servers, routers, switches, or advanced intelligent network devices. For example, the platform 120 may represent one or more web servers that performs the processes and methods herein described.

In one embodiment, the logic engine 122 is the logic that controls various algorithms, programs, hardware, and software that interact to create, modify, update, receive, aggregate, analyze, rank, process, score, communicate, and distribute digital environments 128, content, goods and services 126, alerts, reports, messages, or so forth. For example, the logic 122 may enable drag and drop creation, management, and functionality of the digital environments 128. The logic engine 122 may utilize any number of thresholds, parameters, criteria, algorithms, instructions, or feedback to interact with users and interested parties and to perform other automated processes. The logic engine 122 may represent a processor. The processor is circuitry or logic enabled to control execution of a program, application, operating system, macro, kernel, or other set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor may be a single chip or integrated with other computing or communications elements.

The memory 124 is a hardware element, device, or recording media configured to store data for subsequent retrieval or access at a later time. The memory 124 may be static or dynamic memory. The memory 124 may include a hard disk, random access memory, cache, removable media drive, mass storage, or configuration suitable as storage for data, instructions, and information. In one embodiment, the memory 124 and logic engine 122 may be integrated. The memory 124 may use any type of volatile or non-volatile storage techniques and mediums.

In one embodiment, the cloud system 114 or the platform 120 may coordinate the methods and processes described herein as well as software synchronization, communication, and processes. The third-party resources 130 may represent any number of human or electronic resources utilized by the cloud system 114 including, but not limited to businesses, entities, organizations, individuals, government databases, private databases, web servers, research services, service providers, and so forth. For example, verification of ownership, collaboration, and content moderation may be verified through any number of auditing groups, charitable organizations, watchdog groups, or so forth.

In one embodiment, the platform 120 may implement a blockchain ledger, manager, or technology. In another embodiment, the blockchain ledger may be accessible through sources 129. Any number of existing blockchain companies or providers may be utilized (Aeternity, Ethereum, Bitcoin, Dfinity, ContentKid, Blockphase, Chain of Things, Flowchain, Decissio, Cognate, SkyHive, Safe, etc.). In one example, the platform 120 may be built utilizing the Ethereum blockchain. All or portions of the digital environments 128 and associated content may be monetized as NFTs, tokens, or other aspects of the blockchain. As a result, the platform 120 may allow monetization of the various embodiments.

The blockchain system 115 is utilized as a way to store and communicate digital environments 128, templates, content, and other data and information. The blockchain system 115 may utilize one or more distinct ledgers for different entities, services providers, types of products, users, or so forth. For example, each new seller (or product, good, or service) received by the platform 120 is assigned a secure identifier. The blockchain system 115 may cross-reference updates to the content with the original record for the content to ensure proper licensing, management, and transactions. In one example, different licensing tiers, pricing algorithms, license verification, inaudible tone verification, cause information, and payments are combined to create a unique platform. The illustrative embodiments provide a system 100, cloud system 114, and platform 120 for creating, managing, and updating digital environments 128, content, goods and services 126, communications, and documenting applicable transactions. A user may navigate the digital environments 128 and spaces to explore, purchase products, services, or content, host performances, and connect with other users, hosts, vendors, businesses, organizations, or visitors.

The blockchain system 115 may also be utilized to mint NFTs and create blockchain tokens for utilization on the website. For example, blockchain or cryptocurrency tokens may be utilized for a particular site or event for contents, actions, activities, products, or services, such as entering a room, buying digital swag, participating in livestream conversations, and so forth. The blockchain system 115 may be utilized to create content as an individual, collaborative effort, or so forth.

The blockchain system 115 may also utilize any number of cryptocurrency or standard payment systems (e.g., PayPal, Venmo, Dwolla, wire transfers, credit cards, Quicken, etc.) to receive money and distribute payments. In one embodiment, the platform 120 may receive a small fee or percentage per transaction, purchased item, browsing session, or so forth.

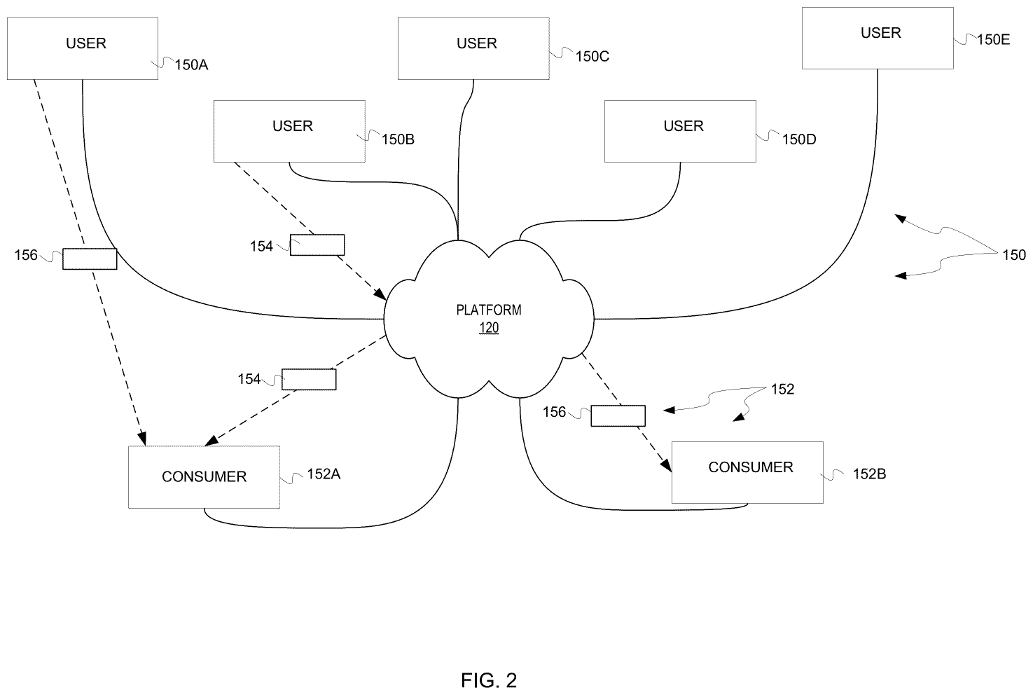

In one embodiment, the platform 120 may be utilized to verify users, content, sellers, and associated goods and services, and digital environments 128 associated with the goods and services. The platform 120 may utilize an application or application eco system utilized by the devices 101 to automatically determine and retrieve applicable data, information, and content associated with the users, content, sellers, goods and services, and digital environments 128. In one embodiment, an initial account setup process may be utilized by the users. Thereafter, information may be automatically retrieved from systems, devices, accounts, services, programs, operating systems or other hardware or software devices or interfaces utilized by the users or sellers (see the devices of FIGS. 1 and 2).

The third-party resources 130 may represent any number of electronic or other resources that may be accessed to perform the processes herein described. For example, the third-party resources 130 may represent government, private, and charitable servers, databases, websites, services, and so forth for creating the digital environments 128 and transactions involving the content. In another example, auditors may verify information provided by businesses with regard to the digital environments 128 associated with the businesses themselves or their associated content.

In one embodiment, the platform 120 may distribute electronic (e.g., in-application messages, email messages, text messages, etc.) and/or print notifications and messages to the user and sellers. For example, event hosts may be notified when attendance thresholds are reached, and additional resources are being added to compensate. The users may also be notified when additional information, data, or details are required.

FIG. 2 further illustrates portions of the system 100 of FIG. 1 in accordance with an illustrative embodiment. As shown the users 150A-E (jointly users 150) may represent the sources 129 of FIG. 1. The users 150 may represent any number of businesses, retailers, service providers, individuals, organizations, entities, or so forth referred to as users 150 or businesses for purposes of simplicity. The consumers 152A, 152B (jointly consumers 152) represent any number of participants, attendees, buyers, users, consumers, groups, or individuals that navigate the digital environments or access content from the users 150 as performed through or enabled by the platform 120. In one embodiment, the platform 120 may represent all or portions of the system 100 of FIG. 1 (including the cloud system 114, servers 116, databases 118). The users 150 may submit environments, content, goods, services, products, and cause information that is aggregated, stored, and verified by the platform 120. The users 150 and consumers 152 may represent any number of individuals or groups (e.g., hundreds, thousands, millions, etc.).

As noted, the users 150 may send links or distribute digital environments 154 through distribution systems (e.g., delivery networks, virtual reality networks, social media, etc.), the cloud system 114, or directly to the consumers 152. In one embodiment, the user or seller 150B may distribute digital environments 154 to the consumer 152A through the platform 120. The platform 120 may perform distribution of the digital environments 154.

In another embodiment, the seller 150A may provide information to the consumer 152A regarding the digital environments through the platform, but distribution of content, goods and services 156 may occur directly between the seller 150A and the consumer 152A. As a result, the platform 120 may facilitate the advertising, marketing, information distribution and retrieval, and sales process without performing distribution. For example, the platform 120 may track or monitor referrals or transactions that are enabled by the platform 120 to receive a referral fee, payment percentages, royalties/licenses, transaction fees, or other agreed upon payments. Distribution of the goods and services 156 may also be performed from or through the platform 120, such as delivery of goods and services 156 from the seller 150B to the platform 120 and then from the platform 120 to the consumer 152B.

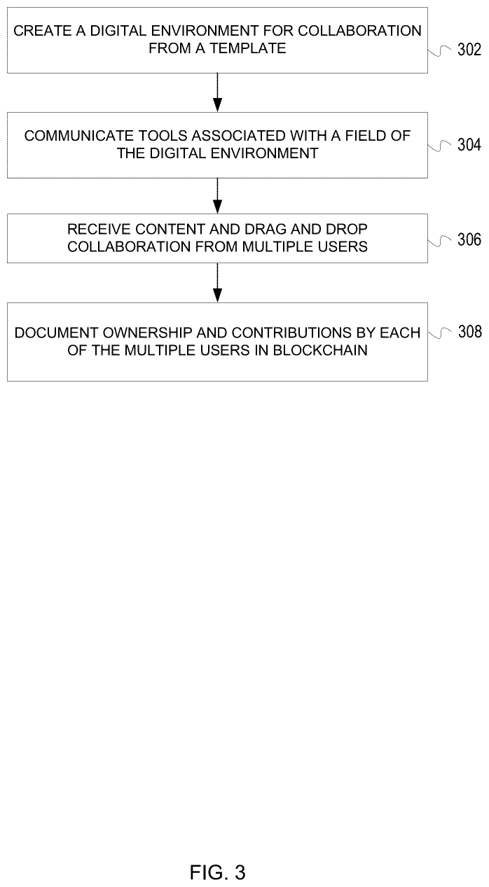

FIG. 3 is a flowchart of a process for creating a digital environment in accordance with an illustrative embodiment. The process of FIGS. 3-5 may be performed by a platform, device, server, system, or other equipment in accordance with illustrative embodiments (referenced as a platform). All or portions of the process of FIG. 3 may be performed automatically. In one embodiment, the process may begin by creating a digital environment for collaboration from a template (step 302). The digital environment may be configured for any number of different devices, platforms, users, or so forth. In one embodiment, the digital environment is a virtual environment, interactive environment, and/or augmented reality environment. The digital environment may be established based on a template available from a library or database storing numerous potential templates. The user may be presented with potential digital environments based on a user profile, previous projects, a survey, user input, or other applicable information.

Next, the platform communicates tools associated with a field of the digital environment (step 304). The tools may also be communicated based on user preferences, history, surveys, natural language descriptors, and so forth. The tools may include any number of previously generated modules, selections, indicators, interactive tools, and so forth. The tools may allow a user to easily create and customize the digital environment without extensive programming or even technical skills.

Next, the platform receives content and drag and drop collaboration from multiple users (step 306). The platform may receive content selections, customizations, settings, content, and other collaborative information and data from one or more users. Any number of devices may be utilized to interact with the platform.

Next, the platform documents ownership and contributions by each of the multiple users in blockchain (step 308). The platform may document the contributions of various parties to document ownership, contributions, and so forth. In one example, multiple users may be able to monetize a single digital environment. The platform may utilize a smart contract or contribution percentages to ensure that each user is compensated for their different contributions and content. For example, artists, musicians, composers, programmers, and creators may be compensated for their contribution to the digital environment. Any number of applicable blockchain systems, or methodologies may be utilized to track contributions to both the digital environment as well as content uploaded to the digital environment by participating users.

FIG. 4 is a flowchart of a process for compensating a user for utilization of a digital environment in accordance with an illustrative embodiment. The process of FIG. 4 may begin by creating a digital environment for one or more users (step 402). As previously noted, the digital environment may be owned, managed, controlled, or monetized by one or more users including businesses, organizations, entities, collaborations, or multiple users.

Next, the platform documents ownership of the digital environment in blockchain (step 404). Ownership and control of the digital environment may be controlled utilizing smart contracts, tokens, shares, stocks, or other controlling interests associated with the digital environment. In one embodiment, tokens that control ownership of the digital environment may be created and issued to the associated users. The tokens or other documentation may be recorded on a digital ledger of the blockchain.

Next, the platform licenses the digital environment or portions of the environment in blockchain (step 406). All or portions of the digital environment may be licensed, sold, or utilized in an agreement. For example, the platform may control smart contracts that may govern the digital environment. In one embodiment, creators that contribute content to the digital environment may be able to individually or collectively license their content. For example, music, audio, NFTs, artwork, or other content may be licensed from or through the digital environment.

Next, the platform compensates the user for utilization of the licensed digital environment (step 408). The user may be compensated utilizing cash, digital transactions, real currency, cryptocurrency, discounts, rebates, or so forth. Payments may be split between a single user or multiple users. In another embodiment, the owner or manager of the digital environment may be compensated and then further distribute payments to individual contributors, creators, professionals, specialists, or so forth. One or more smart contracts, agreements, bargains, or negotiated instruments may govern how the digital environment is monetized and how the various contributors are compensated.

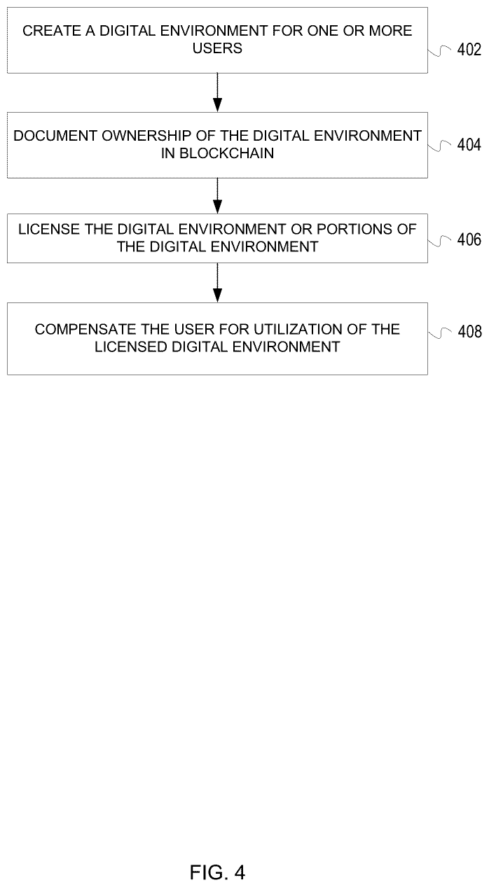

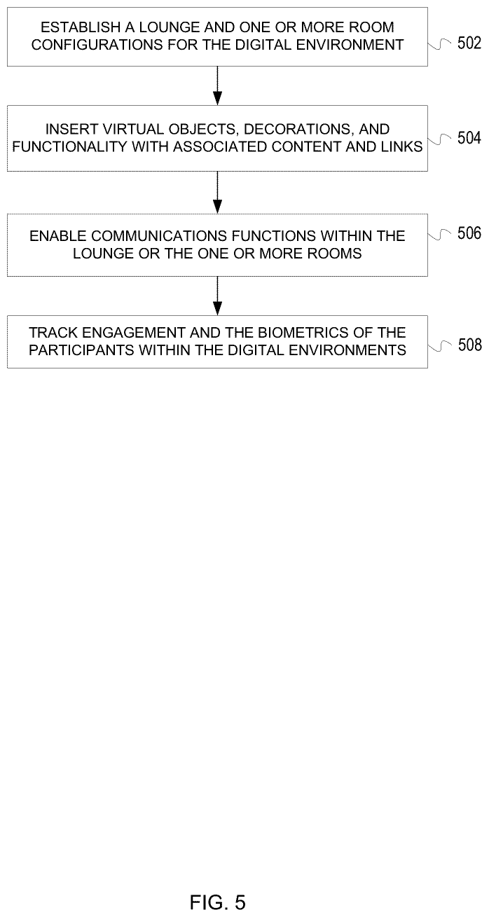

FIG. 5 is a flowchart of a process for implementing a virtual environment in accordance with an illustrative embodiment. The process of FIG. 5 may begin by establishing a lounge and one or more room configurations for the digital environment (step 502). In one embodiment, a virtual environment, augmented reality environment, or other environment is one example of a digital environment as previously disclosed. The virtual environment may include any number of rooms (e.g., dining rooms, living rooms, etc.), lounges, hallways, invitation-only rooms/spaces, password protected rooms/spaces, levels, conference rooms, theaters, and other spaces. Any number of rules, laws, settings, preferences, or other functionality of the virtual environment may be established as part of the process of step 502.

Next, the platform inserts virtual objects, decorations, and functionality with associated content and links (step 504). The virtual object, decorations, and functionality may be associated with music, art, images, files, and any number of other types of content. The virtual objects, decorations, and functionality are used to both decorate the virtual environment as well as prevent functional and decorative information to users of the virtual environment. The platform may have any number of integrated players, viewers, displays, or other applications for making the objects, decorations, and functionality work for the user through the applicable medium (e.g., VR headset, cell phone, computer, augmented reality system, holographic display, etc.).

Next, the platform enables communications functions within the lounge or one or more rooms (step 506). The communications may be performed through any number of video, audio, text, non-verbal, image, or any number of other communications programs. The user may be able to join the communications at any time. In other embodiments, the settings may limit how, when, and where the user may communicate with others within the rooms or lounge.

Next, the platform tracks the engagement and the biometrics of the participants within the digital environments (step 508). The platform may be configured to track the user throughout the virtual environment to maximize the user's experience and engagement with the available content. The platform may also track users to ensure that resources are properly allocated for the most popular activities, attractions, features, and functions. Verification, biometrics, such as fingerprints, voice identification, eye scans, and other applicable information may be implemented. In one embodiment, the user's biometrics may be captured throughout the virtual environment to ensure authorized access to various sections and content of the virtual environment as well as to determine information, such as heart rate, respiration rate, blood pressure, pupil dilation, temperature, and other information that may indicate the status and/or well-being of the user. The user status may indicate whether the user is actively engaged, bored, stimulated, scared, disoriented, happy, sad, or other emotions or conditions of the user. The platform may monitor the well-being of the user to ensure that the health and condition of the user while participating in the virtual environment are optimal. If needed, the platform may suggest water breaks, bathroom breaks, eye rest, food breaks, specific activities within the platform, or any number of other activities or actions that are potentially in the best interest of the user.

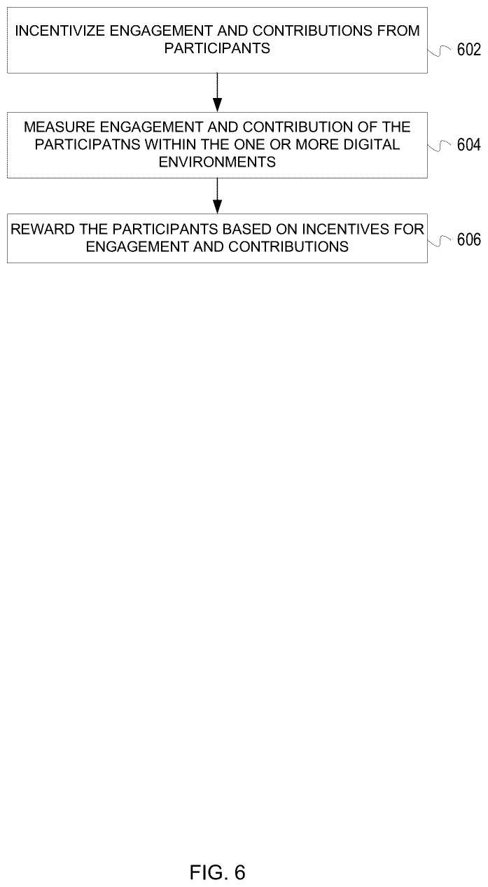

FIG. 6 is a flowchart of a process for rewarding engagement in accordance with an illustrative embodiment. The process may begin by incentivizing engagement and contributions from participants (step 602). The incentives for engagement and contributions of users may be governed according to pre-negotiated agreements, smart contract, provisions, or so forth. The platform may specify the incentives that are available to the user for various activities, actions, content, or so forth. For example, the incentives may be in hard currency, crypto currency, rebates, discounts, in-platform content, or any number of other systems of compensation, payments, or incentives. For example, musicians may be able to set the terms for their music to be played, streamed, purchased, leased, or otherwise monetized within the digital or virtual environment.

Next, the platform measures engagement and contributions of the participants within the one or more digital environments (step 604). The platform may measure and record the movements made by the participants/consumers/users, selections, views, and other activities and actions performed by the user. The contributions may include files, music, artwork, images, names, comments, text, or other applicable content that are uploaded or added to the one or more environments. The platform may track whether the contributions of the user improve or damage the experience for other users.

Next, the platform rewards the user based on incentives for engagement and contributions (step 606). The user may be rewarded utilizing any number of payments, compensation, discounts, points, free or reduced-price content, or so forth.

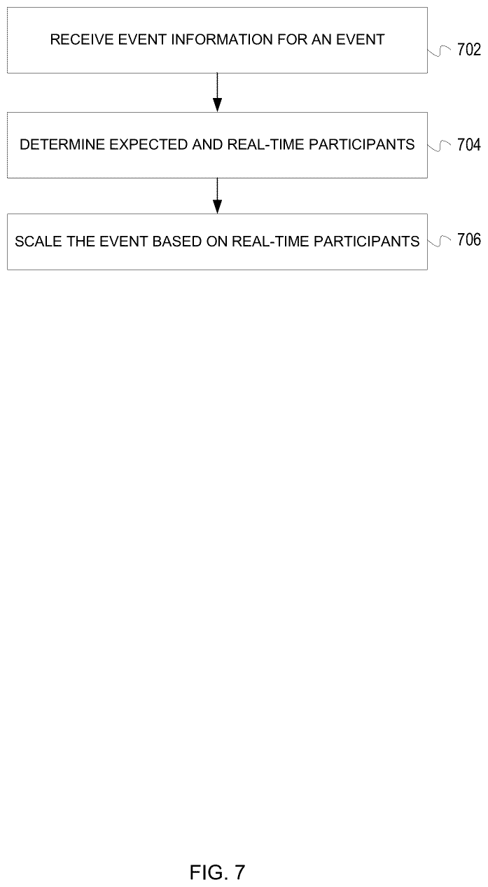

FIG. 7 is a flowchart of a process for configuring an event in accordance with an illustrative embodiment. In one embodiment, an event is another example of a specific digital or virtual environment. The events may be one-time activities, collaborations, or environments, or may be ongoing.

In one embodiment, the process may begin by receiving event information for an event (step 702). The user information may be associated with the owners, managers, or other responsible party or parties associated with the event. The event information may specify the settings, parameters, configurations, limits, thresholds, rules, bi-law s, and other criteria that govern the event as well as activities, actions, behavior, content, and interactions allowed (or not allowed) within or during the event.

Next, the platform determines expected and real-time participants (step 704). The platform may determine the number of participants that are expected based on applicable information, such as reservations, likes, subscriptions, or so forth. The expected participation may be adjusted up or down before and during the event.

Next, the platform scales the event based on real-time participants (step 706). The event may be scaled by adding resources, such as servers, databases, rooms, bandwidth, processing power, software licenses, seats, and other applicable resources (e.g., hardware, software, virtual, manpower, etc.). In one embodiment, the event is scaled automatically based on the in-event information provided by a user, which may include event preferences, user preferences, or so forth. For example, the user may have pre established criteria for automatically expanding the resources based on attendance, and authorizing the additional cost, expenses, and fees that may be associated with scaling the event.

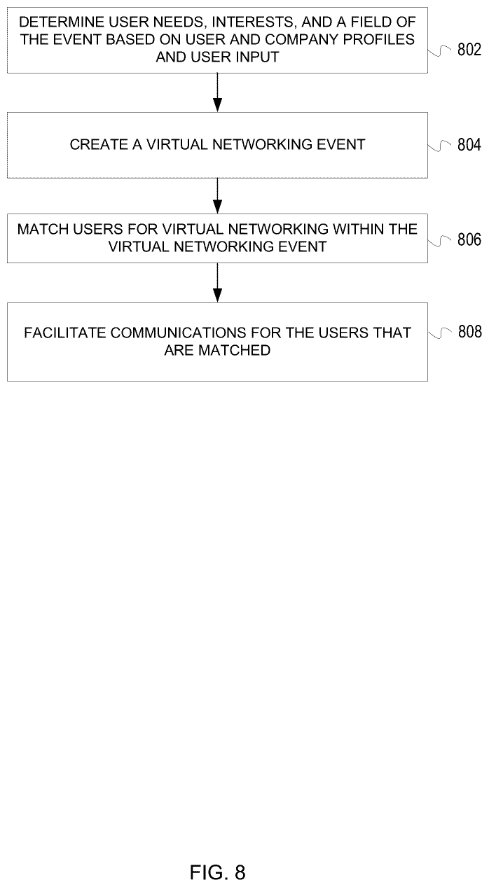

FIG. 8 is a flowchart of a process for creating a virtual networking event in accordance with an illustrative embodiment. The process may begin by determining user needs, interests, and a field of the event based on a user and company profiles and user input (step 802). The information gathered during step 802 may be utilized to automatically customize the virtual networking event. In addition, specific creator tools may be presented to the user based on the applicable information and data. As noted, the information and data may have been gathered previously or may be determined utilizing profiles, surveys, questionnaires, or so forth. The information and data may be gathered at any time before, during, or after creation of the virtual networking event.

Next, the platform creates a virtual networking event (step 804). The virtual networking event may be created for any number of fields, purposes, or intents. The virtual networking event may be created for utilization across different devices utilized by the user, such as virtual reality headsets, gaming systems, desktop computers, laptops, smart phones, tablets, vehicle systems, augmented reality systems, or other applicable devices, equipment, or systems.

Next, the platform matches users for virtual networking within the virtual networking event (step 806). The users may be matched based on any number of information and data, such as that gathered during step 802. For example, the users may be matched based on interests, needs, requests, or other applicable information and data as determined automatically utilizing artificial intelligence, machine learning, or user matching.

Next, the platform facilitates communications for the user's that are matched (step 808). Video, chat, audio, text, or other conferences, calls, or messaging may be utilized to facilitate communications. The various communications features, functions, and software may be integrated with the platform or platforms that are hosting the virtual networking event.

FIG. 9 is a pictorial representation of a tool 900 for creating a digital environment 902 in accordance with an illustrative embodiment. In one embodiment, the tool 900 may be utilized to create a digital environment, such as a virtual, event-based, activations, launches, experiences, galleries, holographic, augmented reality, digital, navigable, transactional, content-rich, and/or functional environment. The tool 900 may be presented as an interactive webpage, program, mobile application, or other interactive tool to allow one or more users to create and customize the digital environment 902. The tool 900 may be utilized to create, modify, and/or update any number of digital environments accessible or managed by the user. The digital environment 902 may be for an event (e.g., concert, collaboration, conference, education, entertainment, etc.), website, mobile application, or other action or activity that may be of limited duration, short-term, long-term, or ongoing.

The tool 900 may include any number of interactive libraries 904, 906 that may include drag-and-drop components, features, and functionality. In one example, the interactive library 902 may include components for a podcast, product gallery, buttons, live chat rooms, social media, voting/polls/surveys, photobooths, live streams, and so forth. The interactive library 906 may include components for a live conference, video, brochures/documents, and live chat features. Any number of widgets or components from the libraries 904, 906 may be dragged and dropped into the digital environment. For example, a video chat room, livestream, or program play schedule (e.g., day, time, content, etc.) may be added to an event. In one example, digital brochures and advertisements, and sponsorships may be placed in the various rooms, lobby, theaters, or so forth. Individual rooms may also be branded (e.g., names, trademarks, logos, slogans, pictures, brochures, advertisements, etc.) with applicable content.

The digital environment 902 may include any number of rooms, spaces (e.g., field, forest, classroom, theater, halls centers, etc.), or other interactive areas. For example, the digital environment 902 may include a lounge, gallery content exchange collaboration room, meeting room, hallway, and so forth. The digital environment 902 may also include any number of game rooms, relaxation rooms, secure communications rooms, auction rooms, tech rooms, and so forth. The digital environment 902 may be configured for easy navigation by any number of users. The digital environment 902 may include interactive decorations, furniture, artwork, appliances, and/or features/functions that may be accessed by any number of users. As previously noted, the resources of the digital environment 902 may be scaled up or down as needed. For example, the back end and front-end resources may be expanded as needed (e.g., servers, intelligent network devices, bandwidth, artificial intelligence support/machine learning, processing, memory, software seats/licenses, etc.). Other resources, such as hosts, operators, moderators, tour guides, and other resources requiring individual users may also be expanded as needed.

The tool 900 allows the user to include the best components of interactive digital experience without downloading any large applications, databases, or so forth. The digital environment 902 may be customized in a way that protects and maintains the brand integrity and creative vision of the user. In addition, the user may utilize the tool 900 to create multiple revenue streams, capture valuable user data, provide low barrier user access, and provide enriching experiences and functionality.

The tool 900 may provide statistics, information, metrics, and data in real-time and for specified time periods. The data and information may be utilized to further customize the digital environment 902.

The illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible or non-transitory medium of expression having computer usable program code embodied in the medium. The described embodiments may be provided as a computer program product, or software, that may include a machine-readable medium having stored thereon instructions, which may be used to program a computing system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object-oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider).

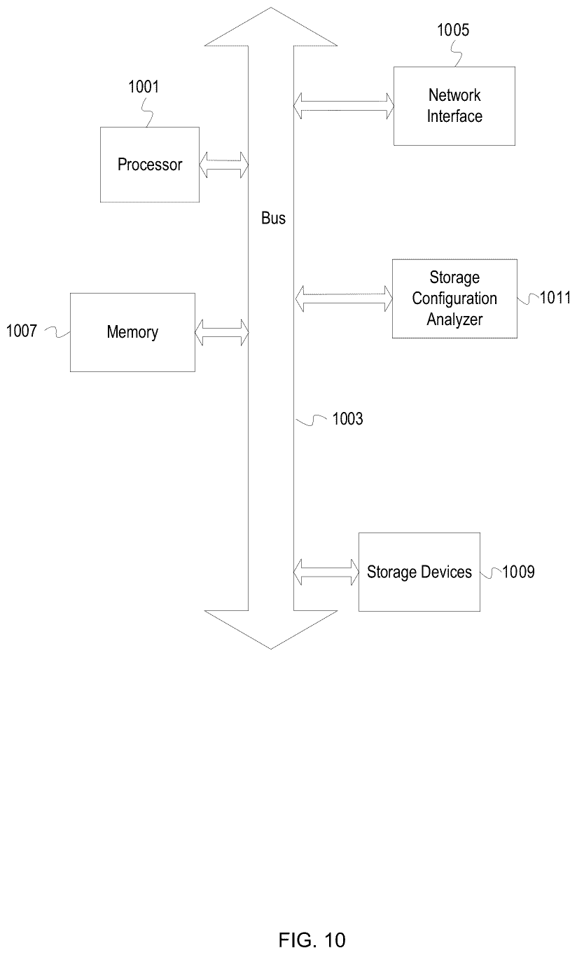

FIG. 10 depicts a computing system 1000 in accordance with an illustrative embodiment. For example, the computing system 1000 may represent a device, such as one or more of the devices 101 of FIG. 1. The computing system 1000 may represent one or more servers that function as the platform 120 of FIG. 1 (or other stand-alone, networked, or cloud devices). The computing system 1000 includes a processor unit 1001 (possibly including multiple processors, multiple cores, multiple nodes, and/or implementing multi-threading, etc.). The computing system includes memory 1007. The memory 1007 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 1003 (e.g., PCI, ISA, PCI-Express, HyperTransport®, InfiniBand®, NuB us, etc.), a network interface 1005 (e.g., an ATM interface, an Ethernet interface, a Frame Relay interface, SONET interface, wireless interface, etc.), and a storage device(s) 1009 (e.g., optical storage, magnetic storage, etc.). The system memory 1007 embodies functionality to implement embodiments described above. The system memory 1007 may include one or more functionalities that store users, sellers, causes, verification information and data, content, blockchain data, parameters, application, user profiles, and so forth. For example, the system memory 1007 may include instructions or hardware for implementing the methods and processes herein described. Code may be implemented in any of the other devices of the computing system 1000. Any one of these functionalities may be partially (or entirely) implemented in hardware and/or on the processing unit 1001. For example, the functionality may be implemented with an application specific integrated circuit, in logic implemented in the processing unit 1001, in a co-processor on a peripheral device or card, etc. Further, realizations may include fewer or additional components not illustrated in FIG. 10 (e.g., video cards, audio cards, additional network interfaces, peripheral devices, etc.). The processor unit 1001, the storage device(s) 1009, and the network interface 1005 are coupled to the bus 1003. Although illustrated as being coupled to the bus 1003, the memory 1007 may be coupled to the processor unit 1001.

The illustrative embodiments may provide a resource for consumers to make purchases in a way that supports society, charity, and other causes the consumers agree with. For example, some statistics show that 90% of shoppers are likely to switch to a cause-based product, 88% of consumers want to hear what brands are doing to have an impact, 64% of shoppers want business to integrate social impact directly into their business model, and 88% of consumers would buy a product with a social or environmental benefit.

The features, steps, and components of the illustrative embodiments may be combined in any number of ways and are not limited specifically to those described. In particular, the illustrative embodiments contemplate numerous variations in the smart devices and communications described. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limited in scope. The following claims set forth a number of the embodiments of the invention disclosed with greater particularity.

What is claimed is:

1. A method for creating a digital environment, the method comprising:
creating a digital environment from a template;
communicating one or more tools associated with a field of the digital environment;
receiving content, and drag-and-drop selections from one or more users;
documenting ownership and contributions by each of the one or more users in blockchain.

2. The method of claim 1, further comprising:
licensing the digital environment or portions of the digital environment to third parties.

3. The method of claim 2, wherein the portions of the digital environment include content uploaded to the digital environment.

4. The method of claim 1, further comprising:
compensating the one or more users for utilization of the digital environment or content associated with the digital environment.

5. The method of claim 4, wherein the one or more users are compensated according to terms of a smart contract.

6. The method of claim 1, further comprising:
establishing a lounge and one or more rooms for the digital environment.

7. The method of claim 1, further comprising:
embedding virtual objects, decorations, and functionalities with associated content and links within the digital environment.

8. The method of claim 6, further comprising:
enabling communications functions within the lounge or one or more rooms.

9. The method of claim 1, further comprising:
track engagements and biometrics of participants within at least the digital environment.

10. A system for generating a digital environment, comprising:
a plurality of electronic devices an interface application, the interface application is configured to communicate one or more digital environments include a digital environment; and
a platform accessible by the plurality of wireless devices executing the interface application through one or more networks, wherein the platform creates the digital environment from a template, communicates one or more tools associated with a field of the digital environment, receives content, and drag-and-drop selections from one or more users, and documents ownership and contributions by each of the one or more users in blockchain.

11. The system of claim 10, wherein one or more of the plurality of electronic devices include virtual reality headsets, and wherein the digital environment is a virtual reality environment.

12. The system of claim 10, wherein the system is a blockchain system, and wherein the digital environment and the content are saved in a digital ledger in communication with the system.

13. The system of claim 10, wherein the platform licenses the digital environment or the content to third parties, and compensates the one or more users for utilization of the digital environment or the content.

14. The system of claim 10, wherein the platform establishes a configuration and one or more rooms for the digital environment, and embeds virtual objects, decorations, and functionalities with associated content and links within the digital environment.

15. A digital environment management platform, comprising:
a processor for executing a set of instructions;
a memory including a digital ledger and for storing the set of instructions, wherein the instructions are executed to:
create a digital environment from a template;
communicate one or more tools associated with a field of the digital environment;
receive content, and drag-and-drop selections from one or more users;
document ownership and contributions by each of the one or more users to the digital environment or content of the digital environment in the digital ledger associated with a blockchain;
compensating the one or more users in response to ownership and contributions as the digital environment is monetized.

16. The digital environment management platform of claim 15, wherein the set of instructions are further executed to license the digital environment or content associated with the digital environment.

17. The digital environment management platform of claim 15, wherein the set of instructions are further executed to compensate the one or more users for utilization of the digital environment or content associated with the digital environment.

18. The digital environment management platform of claim 15, wherein the set of instructions are further executed to establish one or more rooms for the digital environment, and wherein the digital environment represents a virtual reality environment.

19. The digital environment management platform of claim 15, wherein the set of instructions are further executed to enable communications functions within the one or more rooms, and track engagements and biometrics of participants within at least the digital environment.

20. The digital environment management platform of claim 15, wherein the digital environment is communicated to a plurality of wireless headsets that visually display the digital environment and the content.
